(19) United States
(12) Patent Application Publication
(10) Pub. No.: US 2022/0079828 A1
(43) Pub. Date: Mar. 17, 2022

(54) Dorsaint Dressing Lift Legs Support

(71) Applicant: Messeret Dorsaint, Tinton Falls, NJ (US)

(72) Inventor: Messeret Dorsaint, Tinton Falls, NJ (US)

(21) Appl. No.: 17/402,546

(22) Filed: Aug. 15, 2021

Related U.S. Application Data
(60) Provisional application No. 63/077,889, filed on Sep. 14, 2020.

(51) Int. Cl. A61G 13/12

(52) U.S. Cl. CPC A61G 13/1245

(57) ABSTRACT

A support having a mobile stand, a foundation footing base, and a nest receptor for temporarily securing a patient's leg thereupon for examination and/or treatment when placed on a bed, table, chair or floor

### CROSS_REFERENCE TO RELATED APPLICATIONS

A Provisional Patent Application covering the invention described herein was filed on Sep. 14, 2020, and assigned Ser. No. 63/077,889.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### 1. BACKGROUND OF THE INVENTION

As has been reported and has been appreciated by those skilled in the art, the sheer number of leg wound dressings available make choosing the proper dressing a confusing and perplexing problem. Having a wide variety of products to choose from can thus lead to sometimes selecting the wrong or least optimum type of dressing for a particular use. Although there are probably hundreds of dressings now on the market, by and large, they all mostly appear to fall into a few select categories.

For example, gauze dressings used on infected wounds require frequent dressing changes when made of woven or non-woven materials. Transparent film dressings, on the other hand, which allow oxygen to penetrate through the dressing to the wound, can stay in place for as long as one week in permitting visualization of the wound without removal. Foam dressings of hydrophilic film coated gels or polyurethane are highly absorbent, and allow for less frequent change—but may not be suitable for wounds that are not draining. Hydrocolloid dressings are very absorbent in exhibiting a strong adhesive backing, And Alginate dressings are best suited for working on venous ulcers and wounds with heavy exudate. And if all this were not enough, composite dressings as combinations of the foregoing are also available. So too, more and more, are those containing antimicrobials and biosynthetic.

As such, whereas wound care clinicians in the past would simply choose between a handful of products that were essentially variations on the same theme, nowadays there are hundreds of products available, each with their own scientific rationale for selecting one from another.

### 2. OBJECTIVES OF THE INVENTION

In almost every assisted living, long term care, rehabilitation and hospital facility, this proper selection of leg wound dressing is not the only leg issue requiring resolution. Recognizing that many leg dressings in general are required twice a day and more, and can be needed whether it be in a geriatric, orthopedic, or medical surgery environment, the nurses and doctors involved often seem to need a further pair of hands to assist them in lifting the heavy legs of a patient unable to carry out the necessary leg raising and required holding it in place themselves to begin with. As will be understood, this is particularly the situation in a geriatric setting where everyday patients are presenting swelling, deep vein thrombosis and ulcers, breaks, infections and many other problems for the legs—not only with wounds needing treatment.

It is an object of the present invention, therefore, to provide a support for the temporary securement of a patient's leg in position so that the necessary examination and treatment of it, no matter the need or cause, can be facilitated.

It Is also an object of the invention to provide this support in an easily deployable manner.

It is another object to provide such support strong enough to bear the weight of the patient's leg, yet stable enough to be secured in position once the treatment regimen has begun—and, no matter what portion of the leg is involved.

It is yet another objective of the present invention to provide this support without discomforting the patient to any measurably great extent.

And it is a further object of the invention to enable the surgeon, the doctor, the nurse or other medical staff member to be able to set and position this support for use on the surface of a bed, table, chair or floor to best accommodate the procedure being addressed at the time.

### 3. BRIEF DESCRIPTION OF THE INVENTION

As will become clear from the following description, the Dorsaint Dressing Lift Legs Support of the invention comprises a preferably linear stand, having a lower end base foundation or footing, and an upper end nest receptor. Although, a constructed embodiment may have been made of wood, any type of composite or other material may be used instead in satisfying the above stated objectives in enabling examination or treatment procedures to follow of a patient at hand.

### 4. DESCRIPTION OF THE DRAWING & DETAIL OF THE INVENTION

FIG. 1 is a sketch of the Dorsaint Support of the invention, 10.

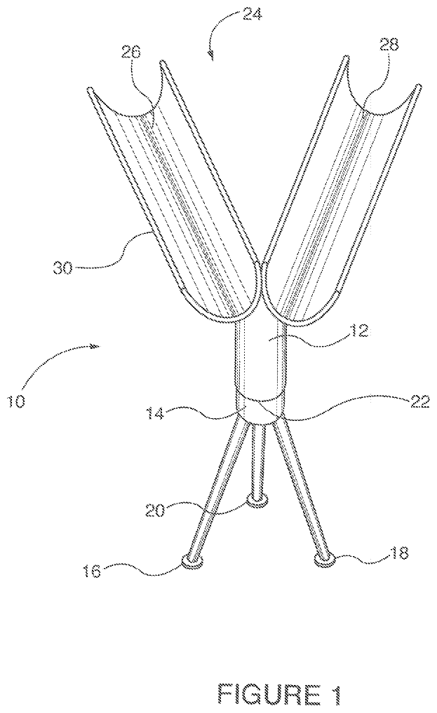

Reference numeral 12 identifies its preferably linear stand, which can be of rectilinear or circular cross-section. The stand 12 may be of fixed length, or adjustably telescopic in any well known or appropriate manner. For positioning on a bed, table, chair or floor surface, a 1′4″ overall length has proven useful.

Reference numeral 14 depicts the lower-end base foundation or footing, essentially of an isosceles three footed, triangularly configured construction, 2 leg ends 16, 18 being substantially co-planar and with the co-planar end of the third leg 20 extending rearward therefrom. As indicated, the foundation or footing 14 joins with the lower end of the stand 12 at 22.

Reference numeral 24 identifies the nest receptor of the support 10, illustratingly shown as a pair of upwardly left and upwardly right extending wing sections 26, 28—between which and upon which the patient's leg is placed to rest, set in place during an examination, testing, and dressing procedure. A leather or other cushioning material (not shown) is emplaced on the upwardly facing surface of both sections to provide a degree of creature comfort to the patient. As indicated at 30, the nest receptor 24 is joined at the upper end of the stand 12.

As will thus be understood by the medical practitioners, the Dorsaint Dressing Lift Leg Support is easily and readily deployable for use, leaving to them substantially only the concern of the more arduous task of raising the patient's leg and placing it in its required position in the nest receptor for the procedure to follow. The ease in deployment and leg positioning thus more readily allows the attendant staff to typically address all the other medical tasks to be attended to at the time.

1. A support for the temporary securement of a patient's leg in position for examination and/or treatment, comprising:
a mobile stand having a lower end and an upper end;
a foundation footing at said lower end; and
a nest receptor at said upper end including left and right upwardly extending wing sections spaced apart to temporarily receive and support when placed upon a bed, table, chair or floor a patient's leg positioned thereupon for examination and/or treatment and removed therefrom thereafter.

2. The support of claim 1 wherein said mobile stand is of one of a rectilinear and circular cross-section.

3. The support of claim 1 wherein said mobile stand is one of a fixed and adjustably telescopic length.

4. The support of claim 1 wherein said foundation footing includes a base of three footed triangular configured construction.

5. The support of claim 1 wherein said foundation footing includes a base of three legs, the ends of two of which are substantially coplanar and with the end of the third of which extends rearward therefrom.

6. The support of claim 1 wherein said nest receptor includes left and right upwardly extending wing sections of cushioning material on facing surfaces thereof.

7. A support for the temporary securement of a patient's leg in position for examination and/or treatment, comprising;
a mobile linear stand of one of a rectilinear and circular cross section, of one of a foxed and adjustably telescopic length, and having a lower end and an upper end;
a foundation footing at said lower end of said stand; and
a nest receptor at said upper end of said stand;
with the foundation footing including a base of three legs, the ends of two of which are substantially coplanar and with the end of the third of which extends rearward therefrom; and
with the nest receptor including upwardly left and upwardly right extending wing sections spaced apart to temporarily receive and support when placed upon a bed, table, chair or floor a patient's leg positioned there between for examination and/or treatment, and removable therefrom thereafter.

8. The support of claim 7 wherein said upwardly left and upwardly right wing sections include cushioning material on facing surfaces thereof.

9. The support of claim 8 constructed of one of a wooden and composite material of a length of the order of 1′ 4″.
